(19) United States
(12) Patent Application Publication
(10) Pub. No.: US 2010/0176964 A1
(43) Pub. Date: Jul. 15, 2010

(54) INSPECTION SYSTEM AND INSPECTION METHOD

(75) Inventors: Kenichi Kobayashi, Kyoto-shi (JP); Masato Ishida, Kyoto-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA MACHINERY, LTD., Kyoto-shi, Kyoto (JP)

(21) Appl. No.: 12/602,052

(22) PCT Filed: Mar. 27, 2008
(86) PCT No.: PCT/JP2008/055872

§ 371 Date: Nov. 25, 2009

(30) Foreign Application Priority Data
Jun. 1, 2007 (JP) 2007-146956

(51) Int. Cl. G08B 5/22

(52) U.S. Cl. 340/825.49

(57) ABSTRACT

The article IDs of a mixture mounting pallet being shipped are read out collectively by means of an ID reader and collated with the ID list on a shipment table. IDs and their positions are stored on the shipment table and the positions of IDs not read out by means of the ID reader are displayed on a handy ID reader and confirmed by a worker using the ID reader.

### TECHNICAL FIELD

The present invention relates to inspection at the time of retrieving articles, e.g., from an automated warehouse or a delivery center.

### BACKGROUND ART

The inventors proposed to provide a transfer apparatus having an ID reader in a station of an automated warehouse for reading IDs of articles to be stored in the warehouse or IDs of articles to be retrieved from the warehouse one by one (Patent Publication 1: WO2006/059676). However, in the case where articles to be retrieved from the warehouse are stacked in a plurality of stages, e.g., on a single item pallet, and the articles are picked up stage by stage, instead one by one, it is difficult to read IDs of the articles using the transfer apparatus. Further, in the case where arrived articles or articles to be shipped are placed on a pallet, a bucket, or the like, and directly stored in, or retrieved from the warehouse, it is unrealistic to read IDs of the articles one by one.

For inspecting articles at the time of arrival of articles, or at the time of shipment of articles, it is convenient to reads IDs of the articles on the pallet or the bucket together at the same time. However, in the case of reading IDs of articles stacked in a plurality of stages, reading errors may occur. In this regard, in the case where a list of IDs read at the time of inspection does not match a list of IDs scheduled to be arrived, or shipped, data of mismatching IDs needs to be checked, e.g., by an operator. For this purpose, it is required to identify positions on the pallet or bucket where the articles having the mismatching IDs are present.

### DISCLOSURE OF THE INVENTION

### Problems to be Solved by the Invention

An object of the present invention is to make it possible to easily inspect articles in units of carriers, and in particular, in the case where a data error occurs, make it possible to easily identify articles having IDs that need to be read again.

Another object of the present invention is to make it possible to easily inspect articles retrieved from a warehouse even if different items of the articles are mixedly placed on a carrier.

Still another object of the present invention is to allow an operator to easily recognize articles having IDs that need to be read again.

### Means for Solving the Problems

According to the present invention, an inspection system includes a memory for storing positions and IDs of articles on a carrier, and an ID reader for reading IDs of the articles. The ID reader is configured to read the IDs of the articles on the carrier together. The inspection system further includes:

collation means for collating the IDs read by the ID reader with IDs stored in the memory to extract IDs that have not been read by the ID reader, from the IDs stored in the memory; and

an output unit for outputting positions of articles having the extracted IDs, from the positions stored in the memory, to an operator.

The carrier may be a pallet, a bucket, or the like. Data is outputted to the operator, e.g., using a display unit of a mobile terminal or a fixed terminal.

Preferably, the carrier is used for retrieval of the articles from a warehouse. The memory is a first memory. The inspection system further includes:

a second memory for storing positions and IDs of articles on a carrier used for storage of the articles in the warehouse; and

transfer means for picking designated articles from the carrier used for storage of the articles and transferring the picked articles to designated positions of the carrier used for retrieval of the articles.

The first memory stores transfer positions of the articles transferred by the transfer means, and store IDs of the transferred articles stored in the second memory.

Further, preferably, the output unit has a display unit for displaying positions of the articles of the extracted IDs three-dimensionally in colors or at brightness levels corresponding to heights of the articles relative to the carrier.

In particular, preferably, the display unit displays a scale showing a height of the carrier by color coding or a difference in brightness.

Further, according to the present invention, an inspection method by storing positions and IDs of articles on a carrier, and reading IDs of the articles using an ID reader to collate the read IDs with the stored IDs is provided. The inspection method includes the steps of:

reading the IDs of the articles on the carrier together using the ID reader;

collating the IDs read by the ID reader with the IDs stored in the memory to extract IDs that have not been read by the ID reader, from the IDs stored in the memory; and

outputting positions of articles having the extracted IDs, from the positions stored in the memory, to an operator.

Description regarding the inspection system is directly applicable to the inspection method. Further, description regarding the inspection method is directly applicable to the inspection system.

### ADVANTAGES OF THE INVENTION

In the present invention, the IDs of the articles on the carrier are read together, and the read IDs are collated with the IDs stored in the memory. Positions of the articles having the mismatching IDs are outputted to the operator. As a result, it is sufficient to retry reading of the IDs of the articles at the outputted positions. The reading errors that tend to occur due to collective reading can be handled simply.

Positions and IDs of the articles on the carrier used for storage of the articles in the warehouse are stored, and the transfer means is used for picking designated articles from the carrier used for storage of the articles and transferring the picked articles to designated positions of the carrier used for retrieval of the articles. The transfer positions of the articles transferred by the transfer means, and IDs of the transferred articles are stored. In this manner, a list indicating positions and IDs of articles on the carrier to be inspected can be created easily. Accordingly, even if different items are mixedly placed on a carrier, the carrier can be inspected easily.

By displaying the positions of articles having IDs that requires retry of reading three-dimensionally in colors, or at brightness levels corresponding to heights of articles, it is possible to clearly display positions of articles having IDs that needs to be read again.

### BRIEF DESCRIPTION OF THE DRAWINGS

FIG. 1 is a block diagram showing an inspection system according to an embodiment.

FIG. 2 is a diagram showing a layout of an ID reader relative to a conveyor in the embodiment.

FIG. 3 is a flow chart showing an inspection algorithm according to the embodiment.

FIG. 4 is a flow chart showing the inspection algorithm after the steps of FIG. 3.

FIG. 5 is a diagram showing a checking mechanism for a shipment table in the embodiment.

FIG. 6 is a view showing an example of a displayed image in the embodiment.

FIG. 7 is a view showing another example of a displayed image.

### DESCRIPTION OF THE NUMERALS

2: inspection system
4: storage and retrieval apparatus
6: transfer apparatus
8: retrieval conveyor
10: ID reader
11, 12: single item pallet
14: mixed pallet
16: handy ID reader
17: communication antenna
18: directional antenna
19: display panel
20: control unit
22: I/O (input/output) interface
24: picking data memory
25: shipment table
26: collating unit
28: inventory data memory
30: image generator unit
32: determination unit
34, 35: antenna
40, 50: displayed image
41, 42: color coding unit
44: color scale
51 to 53: layer

### BEST MODE FOR CARRYING OUT THE INVENTION

Hereinafter, an embodiment in the most preferred form for carrying out the present invention will be described.

### EMBODIMENTS

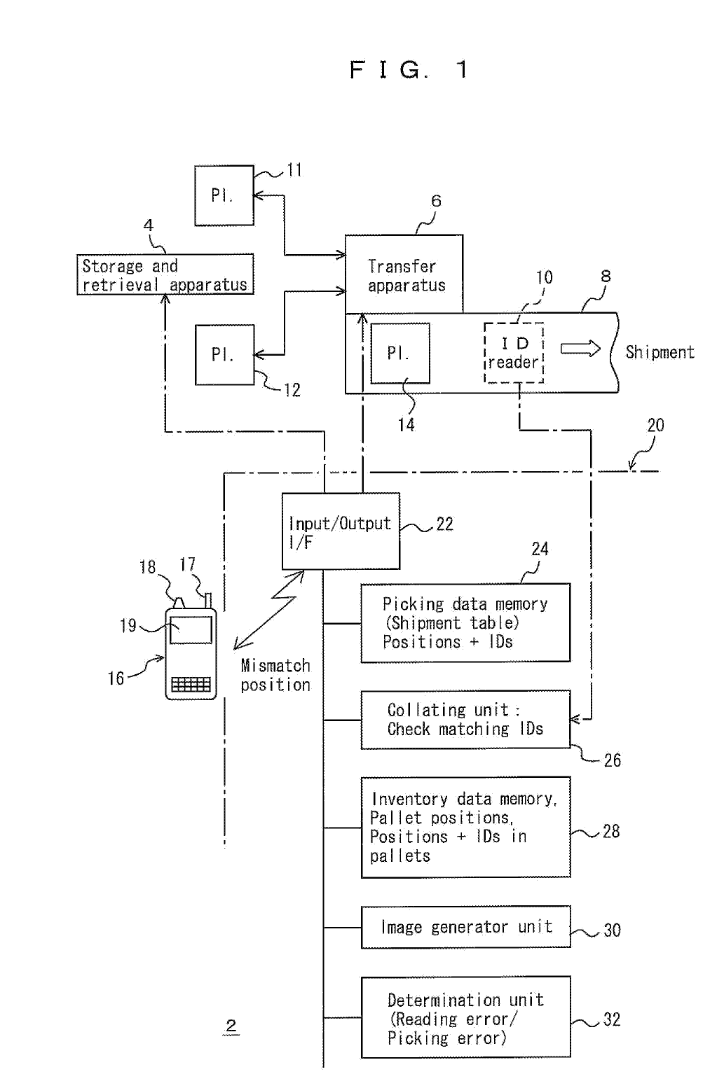

FIGS. 1 to 7 show an inspection system according to the embodiment. In the drawings, a reference numeral 4 denotes a storage and retrieval apparatus such as a stacker crane or a forklift. A reference numeral 6 denotes a transfer apparatus such as a layer picker for picking articles on single item pallets 11, 12 stage by stag for transfer to a mixed pallet 14. A reference numeral 8 denotes a retrieval conveyor for transferring the mixed pallet 14 to, e.g., a shipping station (not shown). A reference numeral 10 denotes an ID reader for reading IDs of articles on the mixed pallet 14 together at the same time. For example, the IDs are RFIDs in the form of ID tags or the like attached to the respective articles on the pallets 11, 12, 14. The transfer apparatus 6 may be a picking robot or the like for transferring the articles from the single item pallets 11, 12 one by one to the mixed pallet 14. Further, the operator may give an instruction for picking from the single item pallets 11, 12, and an instruction regarding a loading position on the mixed pallet 14 for performing transfer operation.

In the embodiment, inspection at the time of shipment of articles from an automated warehouse, a normal warehouse or the like will be described. Alternatively, for inspection at the time of arrival of articles, IDs of articles on the pallet may be read together. Further, in the embodiment, although pallets are shown as carriers where the articles are placed, other carriers such as buckets may be used. Further, in the embodiment, although the ID reader 10 is provided along the retrieval conveyor 8, alternatively, a cart, a forklift, or the like may be used for transporting the mixed pallet 14, and a gate type ID reader may be provided in the middle of a transportation path to read the IDs of the articles on the mixed pallet 14 together.

A reference numeral 16 denotes a handy ID reader used by the operator for manually reading IDs of the articles. A reference numeral 17 denotes a communication antenna for communication with, e.g., input/output (I/O) interface 22 of a control unit 20. A reference numeral 18 denotes a directional antenna for reading an ID at a predetermined position on the mixed pallet 14. The article's ID may be read using a non-directional antenna instead of the directional antenna 18. A reference numeral 19 denotes a display panel such as a color liquid crystal panel.

The control unit 20 has the input/output interface 22 for controlling a storage and retrieval apparatus 4 based on shipment data inputted from a host controller or the like, and transporting the required single item pallets 11, 12 to the transfer apparatus 6 for retrieval or storage of the articles. Further, the transfer apparatus 6 is controlled through the input/output interface 22, and articles at predetermined positions on the single item pallets 11, 12 are transferred to the mixed pallet 14, e.g., by layer picking A picking data memory 24 stores a shipment table. Positions and IDs of articles on the mixed pallet 14 for shipment are stored in the shipment table.

A collating unit 26 collates the IDs of the articles read by the ID reader 10 and the IDs of the articles on the shipment table for checking matching IDs. As a result, by deleting the matching IDs, among the IDs in the shipment table, IDs that have not been read by the ID reader 10 are extracted. An inventory data memory 28 stores data of the single item pallets 11, 12 or the like, such as positions of the pallets in the automated warehouse or the normal warehouse, positions of articles on the pallets, and IDs of the respective articles. At the time of storing articles in the automated warehouse or the normal warehouse, positions and IDs of articles on the single item pallets 11, 12 are detected, and then, stored in the inventory data memory 28. Therefore, by designating pallets and positions on the pallet where the articles to be transferred to the mixed pallet 14 are present, in the storage and retrieval apparatus 4 and the transfer apparatus 6, IDs of required articles in the shipment table can be identified. Further, positions of the articles in the mixed pallet 14 can be identified based on control data transmitted to the transfer apparatus 6.

Positions and IDs of the articles on the single item pallets 11, 12 may not be read at the time of storage of the articles, and these items of data may be received from the host controller or the like. Further, in the case of performing picking operation by the picking robot or manually, data regarding the positions and IDs of the articles on the mixed pallet 14 may be created while reading the IDs of the articles during the picking operation, without managing data of the single item pallets 11, 12.

An image generator unit 30 generates a color image to be displayed on a display panel 19. This image displays positions of the articles on the mixed pallets 14 three-dimensionally, for the articles that have not been read by the ID reader. For example, this image is a bird' eye image. In the case where articles are located at positions visible from the viewpoint, the articles having IDs that have not been read can be identified easily. In order to display positions of articles that are hidden inside other articles stacked in stages, the articles are color coded, or displayed at different brightness levels depending on the heights from the surface of the pallet. By highlighting the articles having IDs that have not been read, even the positions of articles hidden inside other articles stacked in stages can be displayed clearly. Data such as the number of stages of articles on the mixed pallet 14, stacking patterns, and positions of articles having IDs that have not been detected may be transmitted from the input/output interface 22 to the handy ID reader 16 to create the display image by the handy ID reader 16.

The determination unit 32 determines whether there is any reading error or picking error based on the collation result from the collation unit 26 and the result of retry of reading by the handy ID reader 16. The reading error is a case where the articles having IDs according to the shipment table are present on the mixed pallet 14, and the picking error is a case where the actual ID list of articles on the pallet 14 does not match the shipment table.

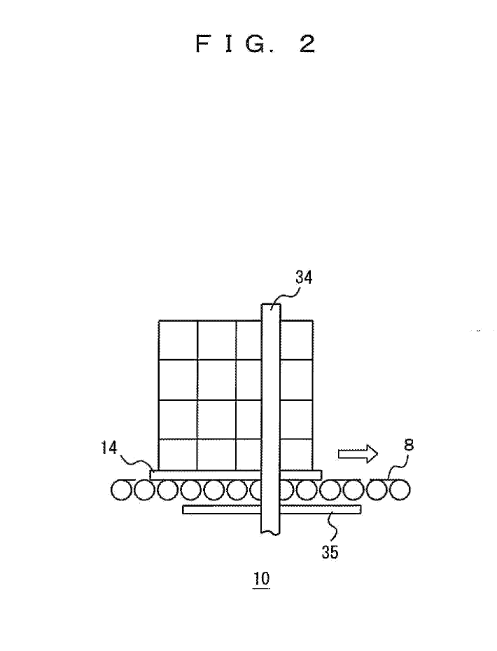

FIG. 2 shows structure of the ID reader 10. Reference numerals 34, 35 denote antennas for reading RFIDs. The antenna 34 is provided on the conveyor 8 like a gate. The antenna 35 is provided at the bottom of the conveyor 8 for reading IDs of articles on the lower side of the mixed pallet 14. It should be noted that only one of the antenna 34 and the antenna 35 may be provided.

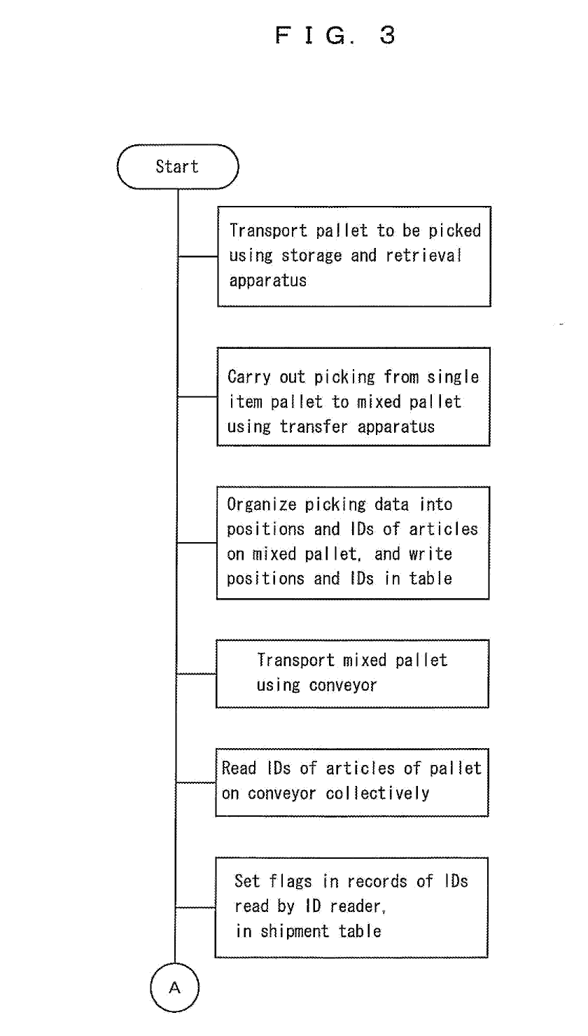

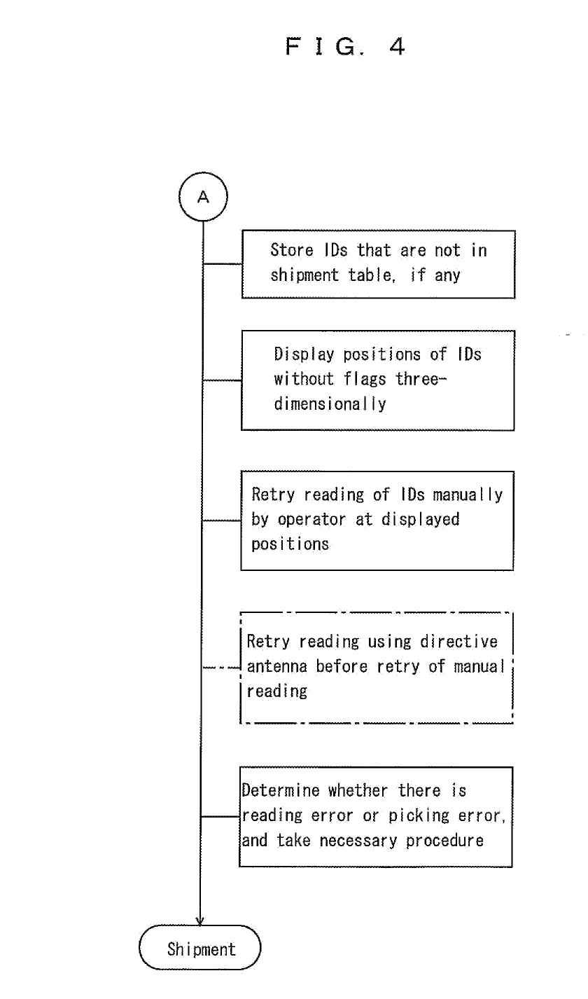

FIGS. 3 and 4 show an inspection algorithm according to the embodiment. The storage and retrieval apparatus transports the single item pallet to be picked to the transfer apparatus, and the transfer apparatus transfers the articles from the single item pallet to the mixed pallet. At this time, a list of combination of positions and IDs of articles on the mixed pallet is generated based on data of positions and IDs articles managed by the inventory data memory and a picking instruction to the transfer apparatus, indicating correspondence between articles on the single item pallet and destination positions of articles on the mixed pallet. The list is written in the shipment table. In the case where picking operation is carried out by a picking robot or manually, IDs of articles are read each time the articles are picked, and a list of combination of the positions and the IDs of the articles is created. Then, the mixed pallet is transported by the conveyor, and the IDs of the articles on the mixed pallet are read together by the ID reader. Thereafter, among the records of shipment table, flags are set in records of IDs read by the ID reader.

Referring to FIG. 4, when any of IDs read by the ID reader are not present in the shipment table, this data is stored. The positions of the IDs having no flags are displayed three-dimensionally on the display panel of the handy ID reader. Instead of displaying an image, for example, a voice message, e.g., “upper right corner in the third stage” may be used to notify the position of the article having an ID that has not been read to the operator. The operator uses the handy ID reader to retry reading of the ID of the article, at the position displayed on the display panel. Alternatively, an additional ID reader having an antenna with high directivity may be provided along a shipment conveyor or the like to transport the mixed pallet toward the antenna, before retry of reading by the operator, and reading the ID may be retried by orienting the directive antenna toward the ID which has not yet been read. Based on the reading result by the handy ID reader, it is determined whether there is a reading error of the ID or an error in picking itself. In the case where there is simply a reading error of the ID, the mixed pallet is shipped directly. In the case where there is a picking error, picking is performed again, e.g., by manually.

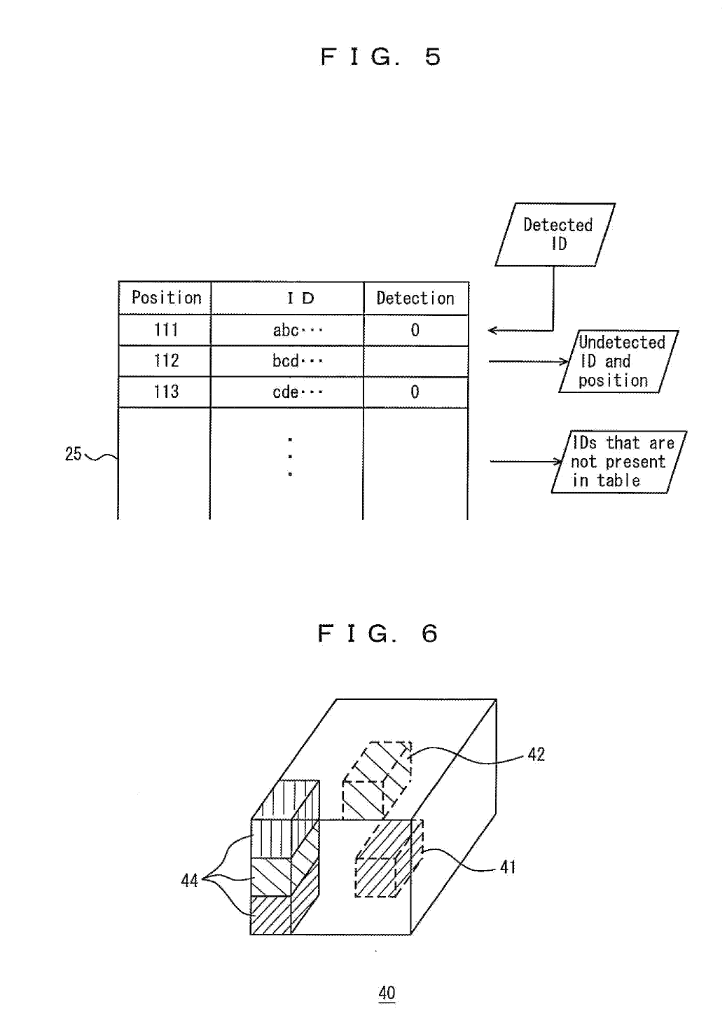

FIG. 5 shows a process regarding the shipment table 25. Positions and IDs of articles are written in the shipment table 25, and flags for IDs detected by the ID reader are set. If any of the IDs detected by the ID reader are not present in the table 25, the IDs are stored. After processing of the IDs that have been read by the ID reader is finished, based on the flags, the IDs that have not been read and the corresponding positions of the articles are determined. Further, the IDs that are not listed in the shipment table, but read by the ID reader are determined.

FIG. 6 shows an image 40 displayed on a display panel of the handy ID reader. Color coded blocks 41, 42 show articles having IDs that have not been detected. The color coding is determined based on the height from the pallet. Color coding depending on the height from the pallet is shown in color scales 44. For example, it can be seen that the color coded block 41 represents an article in a first layer of the pallet, and the color coded block 42 is an article in a second layer of the pallet. Since the displayed image 40 shows articles on the pallet in a bird-eye view, the positions of the articles that require retry of reading are identified easily. In the drawing, though the color scales 44 are provided at the positions of the articles that have been read successfully, the color scales 44 may be provided at positions remote from the pallet.

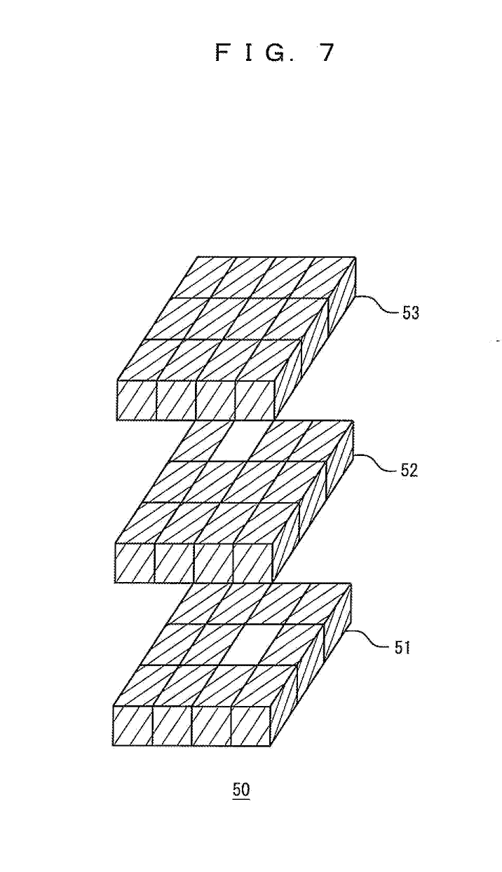

FIG. 7 shows a displayed image 50 according to a modified embodiment. Reference numerals 51 to 53 denote layers as stages of articles. The layers of the articles having IDs that have not been read and the articles having IDs that have been read are color coded. It should be noted that the reading results of the IDs are the same in FIGS. 6 and 7. In the displayed image 40 of FIG. 6 where the bird-eye view and color scales 44 are used in combination, the articles of the IDs that have not been read are shown compactly in comparison with the displayed image 50 of FIG. 7. In the embodiment, though color coding is adopted, in the case of displaying a monochromatic image, the heights of articles having IDs that have not been read may be expressed by displaying the IDs at different brightness levels.

1. An inspection system comprising a memory for storing positions and IDs of articles stacked in a plurality of layers on a carrier, and an ID reader for reading IDs of the articles, the ID reader being configured to read the IDs of the articles on the carrier together, the inspection system further comprising:
collation means for collating the IDs read by the ID reader with IDs stored in the memory to extract IDs that have not been read by the ID reader, from the IDs stored in the memory; and
an output unit for outputting positions of articles having the extracted IDs, from the positions stored in the memory, to an operator.

2. The inspection system according to claim 1, the carrier being used for retrieval of the articles from a warehouse, the memory being a first memory, the inspection system further comprising:
a second memory for storing positions and IDs of articles on a carrier used for storage of the articles in the warehouse; and
transfer means for picking designated articles from the carrier used for storage of the articles and transferring the picked articles to designated positions of the carrier used for retrieval of the articles,
the first memory being configured to store transfer positions of the articles transferred by the transfer means, and store IDs of the transferred article stored in the second memory.

3. The inspection system according to claim 1, the output unit having a display unit for displaying positions of the articles of the extracted IDs three-dimensionally in colors or at brightness levels corresponding to heights of the articles relative to the carrier.

4. The inspection system according to claim 3, the display unit being configured to display a scale showing a height of the carrier by color coding or a difference in brightness.

5. An inspection method by storing positions and IDs of articles stacked in a plurality of layers on a carrier, and reading IDs of the articles using an ID reader to collate the read IDs with the stored IDs, the inspection method comprising the steps of:
reading the IDs of the articles on the carrier together using the ID reader;
collating the IDs read by the ID reader with the IDs stored in the memory to extract IDs that have not been read by the ID reader, from the IDs stored in the memory; and
outputting positions of articles having the extracted IDs, from the positions stored in the memory, to an operator.
